(19) United States
(12) Patent Application Publication
(10) Pub. No.: US 2011/0262749 A1
(43) Pub. Date: Oct. 27, 2011

(54) THERMAL INSULATOR, THERMAL INSULATING COMPONENT, METHOD OF MANUFACTURING THERMAL INSULATING SMALL FIBER AND METHOD OF MANUFACTURING THERMAL INSULATOR

(76) Inventor: Eisuke Sasaoka, Yokohama-shi (JP)

(21) Appl. No.: 13/094,550

(22) Filed: Apr. 26, 2011

(30) Foreign Application Priority Data
Apr. 26, 2010 (JP) P2010-100973

(51) Int. Cl. D02G 3/00; B29C 67/20; B29C 67/00

(52) U.S. Cl. 428/401; 264/101; 264/41

(57) ABSTRACT

The present invention enables easy manufacturing of a thermal insulating fine fiber and the like, for example, having a high degree of freedom in size and shape and excellent thermal insulating properties. In a manufacturing method according to the present invention, a first end of a preform constituted by bundling a plurality of pipes 1 is sealed, and suction of inner gas of each of the pipes is carried out from a second end side of the preform. By heating the preform with the internal pressure of each of the pipes being thus reduced from the first end side and drawing the preform, a fine fiber is made from the preform. While drawing the preform, by intermittently providing the fine fiber with sealing portions for sealing holes in the fine fiber, a thermal insulating fine fiber is manufactured.

### BACKGROUND OF THE INVENTION

1. Field of the Invention

The present invention relates to a thermal insulator, a thermal insulating component including a thermal insulator, a method of manufacturing a thermal insulating fine fiber, and a method of manufacturing a thermal insulator.

2. Related Background Art

Various forms of a thermal insulating component are known and, for example, a thermal insulator and a thermal insulating component in the form described in Japanese Patent Application Laid-Open No. 6-252074 (Document 1), Japanese Patent Application Laid-Open No. 2000-203855 (Document 2), and Japanese Patent No. 3513142 (Document 3) are known.

Document 1 describes, as a conventional technology, a thermal insulating component, in which silica glass wool is filled inside a silica glass frame and the silica glass frame is sealed while the inside thereof is in a decompressed state. Document 1 discloses a thermal insulator constituted by amorphous high-pure silica glass foaming bodies of decompressed independent air bubble.

Document 2 discloses a thermal insulating component, in which particulate porous silica bodies are filled inside a hollow outer shell comprised of silica glass and the outer shell is vacuum-sealed. Document 3 discloses a thermal insulating component, in which a core material constituted by an inorganic fiber assembly is covered with a jacketing material having gas barrier properties and the inside of the jacketing material is reduced in pressure.

### SUMMARY OF THE INVENTION

The present inventors have examined the conventional thermal insulating components described above, and as a result, have discovered the following problems.

That is, the thermal insulating component described as the conventional technology in Document 1 has a structure that the silica glass frame filled with silica glass wool is sealed in the decompressed state. Therefore, as the silica glass frame becomes larger, there is an increased possibility that a pressure difference between inside and outside the silica glass frame causes destruction of the silica glass frame. Accordingly, it was difficult to make the thermal insulating component larger.

In the thermal insulating component disclosed in Document 1 above, when an outer shell is filled with a silica glass foaming body, it is necessary to process the silica glass foaming body so as to correspond to the shape of the outer shell. However, processing the silica glass foaming body is difficult and a degree of freedom in shape is low.

In the thermal insulating component disclosed in Document 2 above, while a hollow outer shell is filled with porous silica bodies, the outer shell is vacuum-sealed. Therefore, the shape of the thermal insulating component is determined by the shape of the outer shell, and the degree of freedom in shape is low.

In the case of the thermal insulating component disclosed in Document 3 above, the degree of freedom in shape is increased by a flexible material used for the jacketing material having gas barrier properties. On the other hand, there is a risk that any damage to the jacketing material causes vacuum break and therefore deterioration of thermal insulating properties, so a trade-off exists between the degree of freedom in shape and the thermal insulating properties.

The present invention has been developed to eliminate the problems described above. It is an object of the present invention to provide a thermal insulator capable of having excellent thermal insulating properties and a thermal insulating component including it. Furthermore, it is an object of the present invention to provide a method of easily manufacturing a thermal insulator and a thermal insulating fine fiber having a high degree of freedom in size and shape and excellent thermal insulating properties.

One example of a thermal insulator according to an embodiment may be an assembly of a plurality of fine fibers (fibers having small diameters) obtained by the method of manufacturing described above. In such a case, it is preferable that an average outer diameter of fine fibers be 1 μm or more and 10 μm or less; a plurality of holes, having an average outer diameter of 500 nm or less in a cross section of each fine fiber, exist in each fine fiber; and the internal pressure of each hole is below atmospheric pressure.

Another example of the thermal insulator according to the present embodiment includes a fine fiber having a plurality of holes inside and an average outer diameter of 10 μm or less. In such a case, each hole is sealed at both ends or at a plurality of places in an intermediate zone between both ends and the internal pressure of each sealed hole is reduced below atmospheric pressure.

In each example of the thermal insulator according to the present embodiment, the internal pressure of each hole is preferably 10 kappa or less. Additionally, the fine fibers constituting the thermal insulator are preferably comprised of glass.

One example of a thermal insulating component according to an embodiment includes an assembly of a plurality of members each having the same structure as the thermal insulator described above (the thermal insulator according to the present embodiment). Furthermore, the thermal insulating component preferably comprises at least one of a structure in which the outside of the assembly is covered with a jacketing material and a structure in which space between the members constituting the assembly is filled with a binder.

One example of a method of manufacturing a thermal insulating fine fiber according to an embodiment uses a preform constituted by bundling a plurality of pipes, and having a first end and a second end opposing the first end. In the preform, while a first end side is being sealed, suction of inner gas of each pipe is carried out from a second end side, so that the internal pressure of each pipe is set to be reduced below atmospheric pressure. In the manufacturing method, by starting softening from the first end side of the preform with the internal pressure of each pipe being reduced, and drawing the preform while shifting a softened region toward the second end side, a fine fiber is made from the preform. While drawing the preform (drawing itself continues), a plurality of sealing portions are formed in the fine fiber intermittently (at regular intervals). Forming the sealing portions is, for example, carried out by intermittently changing, at a softened portion of the fine fiber obtained by drawing, at least one of temperature, the number of twists, tension, the internal pressure of each pipe, and external pressure. As a result, the thermal insulating fine fiber is manufactured while a plurality of holes, fixed and reduced in pressure by the sealing portions, are intermittently provided inside each pipe.

Furthermore, in the method of manufacturing a thermal insulating fine fiber according to the present embodiment, the thermal insulating fine fiber may be manufactured by preparing a preform having a plurality of holes extending in a longitudinal direction thereof, and drawing the preform in the longitudinal direction while softening the preform. In such a case, the manufacturing method comprises a sealing step and a non-sealing step, and the sealing step is carried out before and after the non-sealing step. It should be noted that in the sealing step, while drawing the preform, a sealing portion for sealing each hole is formed in the fine fiber obtained by drawing. Additionally, in the non-sealing step, the preform is drawn under such conditions that the internal pressure of each hole is reduced below atmospheric pressure and each hole still remains. It should be noted that in the sealing step, a plurality of such sealing portions are intermittently formed inside each hole by intermittently changing, at a softened portion of the fine fiber obtained by drawing, at least one of temperature, the number of twists, tension, the internal pressure of each hole, and external pressure. Additionally, in a downstream side of where the sealing portions are formed, the fine fiber is hardened, whereby a plurality of sealed regions, fixed and reduced in pressure by the sealing portions, are intermittently provided inside each hole.

Furthermore, a yet another example of the method of manufacturing a thermal insulating fine fiber according to the present embodiment uses a preform including a large number of fine foaming regions that are expanded with heat. In the manufacturing method, heating the preform expands the foaming regions, producing a large number of holes corresponding to the fine foaming regions. While the foaming regions are expanded, the preform softened with the heat is drawn under pressure below atmospheric pressure, whereby a fine fiber is produced. Additionally, in a downstream side of where the preform is drawn, the fine fiber is cooled down and hardened. A fine fiber, in which internal pressure of each hole generated sue to expansion is controlled to be below atmospheric pressure in a state of the hardened fine fiber, is produced by adjusting temperature of the heat and the pressure applied to the preform in an expansion condition when drawing the preform.

It should be noted that the preform used in each example of the method of manufacturing a thermal insulator according to the present embodiment is preferably comprised of glass. In addition, in one example of a method of manufacturing a thermal insulator according to an embodiment, the thermal insulating fine fiber manufactured as described above constitutes a part or the whole of the thermal insulator.

### BRIEF DESCRIPTION OF THE DRAWINGS

FIG. 1 is a view showing a cross-sectional structure of a preform;

FIG. 2 is a view showing a structure on a side surface of the preform;

FIG. 3 is a view showing a configuration of a device for producing a fine fiber from the preform;

FIGS. 4A and 4B are views showing a cross-sectional structure of the fine fiber manufactured by the device of FIG. 3;

FIGS. 5A and 5B are views showing a structure on a side surface of the preform including a foaming material, and a cross-sectional structure of the fine fiber obtained from the preform; and

FIGS. 6A and 6B are views showing examples of a configuration of a thermal insulator including a plurality of fine fibers.

### DESCRIPTION OF THE PREFERRED EMBODIMENTS

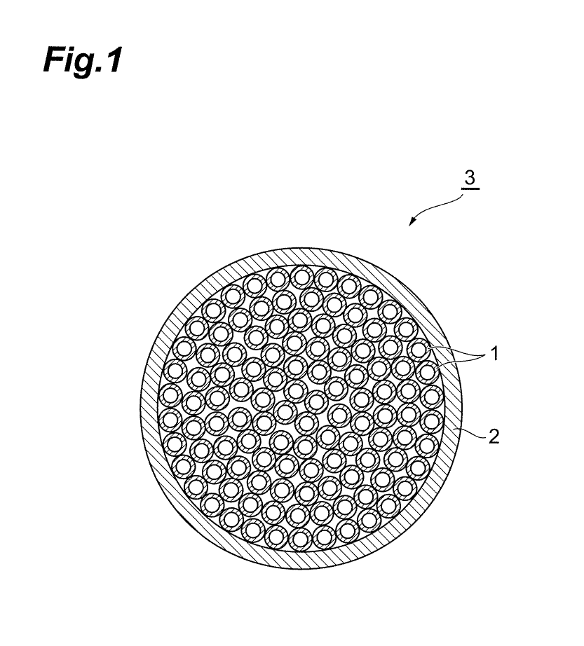

In the following, embodiment of a method of manufacturing a thermal insulating fine fiber and the like according to the present invention will be described in detail, with reference to FIGS. 1 to 3 and 4A to 6B. In the description of the drawings, identical or corresponding components are designated by the same reference numerals, and overlapping description is omitted.

In one example of the manufacturing method according to the present embodiment, first, as shown in FIG. 1, a plurality of hollow pipes 1 (e.g., 400 pieces) are bundled and the bundled hollow pipes 1 are inserted into a hollow pipe 2, and then the pipes 1 and the pipe 2 are heated and fused together to obtain a preform 3. An inner diameter of each pipe 1 is nearly the same, an outer diameter thereof is also nearly the same and a length thereof is also nearly the same. The pipe 1 and the pipe 2 are each comprised of silica glass. It should be noted that the preform may be produced without using the pipe 2 by heating and fusing together the pipes 1 that are bundled to have a nearly circular as a cross sectional shape.

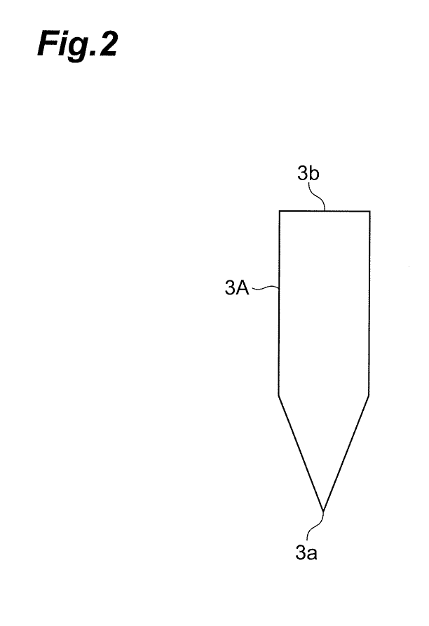

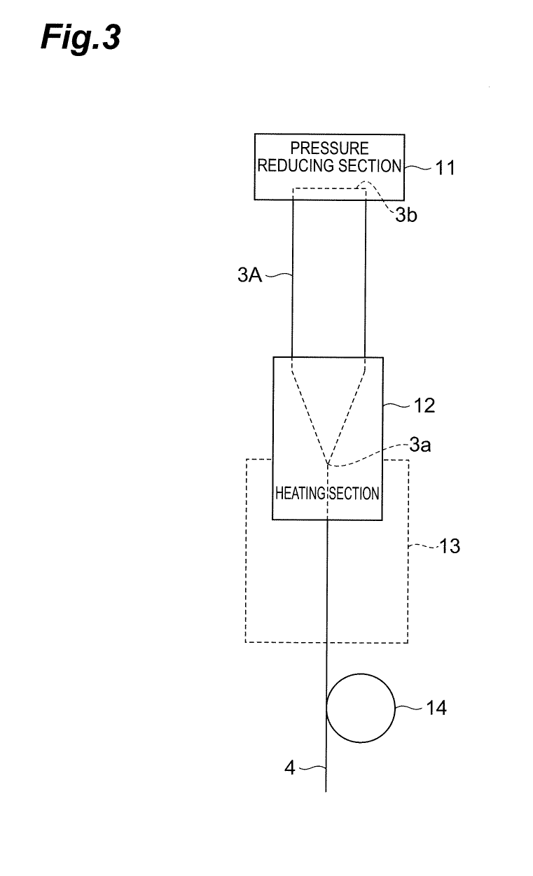

A preform 3A with a first end 3a side sealed is obtained, as shown in FIG. 2, by elongating while heating the first end 3a side of the preform 3 manufactured as described above. On a second end 3b side of the preform 3A, each hole of the pipe 1 is open. As shown in FIG. 3, the second end 3b of the preform 3A is connected to a first pressure reducing section 11 and from the second end 3b side, suction of internal gas (air) of each pipe 1 is carried out by the first pressure reducing section 11. The inside of each pipe 1 is thereby reduced in pressure below atmospheric pressure. Since the first end 3a side of the preform 3A is set in a reduced pressure environment by a second pressure reducing section 13, each inside of the pipe 1 is maintained reduced in pressure below atmospheric pressure and without being crushed. In such a state, the first end 3a side of the preform 3A is heated by a heating section 12. By drawing the first end 3a of the preform 3A softened with heat into thread, a fine fiber 4 is formed from the preform 3A. At that time, tension applied to the softened first end 3a of the preform 3A is set by a tension applying section 14.

When drawing (elongating), at least one of the internal pressure of each pipe 1 reduced by the first pressure reducing section 11; temperature at the first end 3a side of the preform 3A heated by the heating section 12; the ambient pressure of the fine fiber 4 at the first end 3a side of the preform 3A reduced by the second pressure reducing section 13; tension applied to the fine fiber 4 in a softened portion at the first end 3a side of the preform 3A by the tension applying section 14; and the number of twists applied to the fine fiber 4 in the softened portion at the first end 3a side of the preform 3A; is intermittently controlled.

By carrying out any one or more control operations, that are; reducing pressure inside each pipe 1 by increasing a degree of pressure reduction of the first pressure reducing section 11; further softening the fine fiber by increasing heating temperature of the heating section 12; increasing differential pressure applied to each pipe 1 by increasing the pressure of the second pressure reducing section 13 and thereby increasing the pressure applied to the fine fiber 4 around the first end 3a side; increasing the tension applied to the fine fiber 4 in the softened portion at a point end of the first end 3a side of the preform 3A by increasing the tension of the tension applying section 14; and conveying the twists to the softened portion at the first end 3a side of the preform 3A by giving the twists to the fine fiber 4; a sealing portion is formed in each hole of the fine fiber 4.

Such control affects the fine fiber close to the point end of the preform 3A that is in the most softened state. As a result, the fine fiber 4 having the holes sealed intermittently in a drawing direction (elongating direction) is obtained. Along the longitudinal direction of the fine fiber 4, a non-sealing portion where the holes still remain is formed between intervals of a sealing portion where the plurality of holes are sealed. The fine fiber 4 has the plurality of holes in the non-sealing portion, which are equivalent to 400 pieces of the pipe 1 in a circular cross section having an outer diameter of 5 μm, for example.

It should be noted that the method of intermittently sealing the holes (forming the sealing portion) along the longitudinal direction of the fine fiber 4 is not limited to the one described above. For example, unitary fine fibers, each having both ends sealed after drawing, are assembled to make a bundle, and a part of the bundle is partially heated so that a group of the bundled fine fibers is collectively softened. By applying pressure from the side or applying tension in the longitudinal direction to the group of fine fibers thus softened and thereby crushing the holes in the group of fine fibers, it is also possible to seal the holes intermittently.

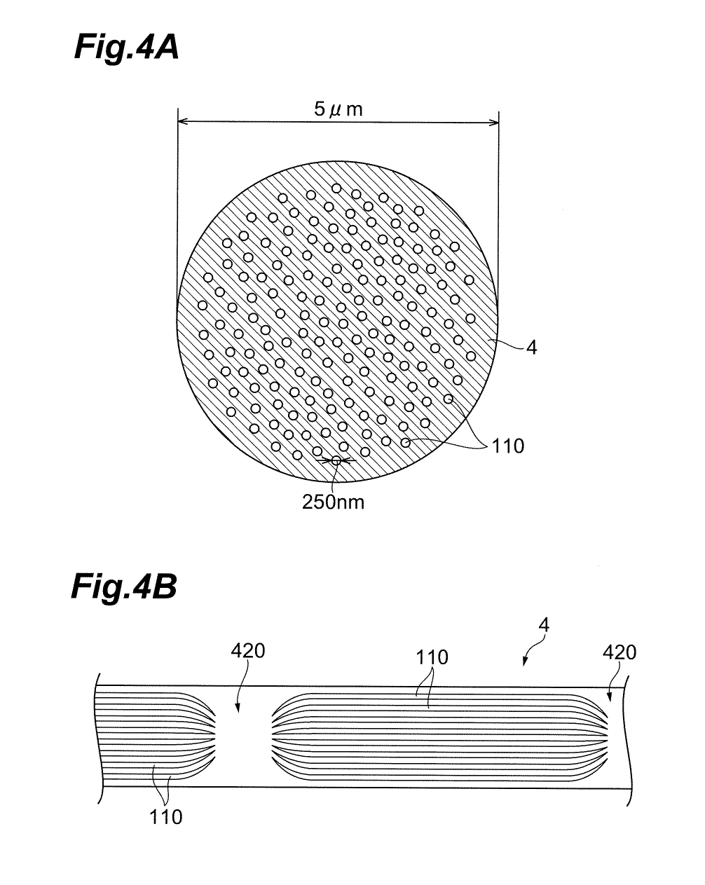

When producing the fine fiber 4 from the preform 3A, a heated portion (at the first end 3a side) of the preform 3A by the heating section 12 is provided with an intermittently sealing structure in the longitudinal direction, and is exposed to the atmospheric pressure environment, after reaching temperature at which a glass fiber is hardened to the extent that a hole portion remains uncrushed by atmospheric pressure. A void portion (non-sealing portion) that is sealed in a reduced pressure state is cooled down to normal temperature while the volume thereof is maintained, resulting in the internal pressure of the void portion decreasing further. Generally, the internal pressure can be reduced to 10 kPa or less, that is about one tenth of atmospheric pressure. In addition, since there exist the holes equivalent to 400 pieces of the pipe 1 in a cross section of the fiber having an outer diameter of 5 μm, it is possible, as shown in FIG. 4A, to set a diameter of an average hole 110 in a cross section of the fine fiber 4 (corresponding to a plane perpendicular to the longitudinal direction of the fine fiber 4) to about 250 nm. Furthermore, FIG. 4B shows a cross section of the fine fiber 4 (corresponding to a plane including the longitudinal direction of the fine fiber 4) and as described above, in the fine fiber 4, a sealed porion 420 where each hole 110 is sealed, is formed intermittently (periodically at regular intervals) along the longitudinal direction and between the sealing portions, there exists a non-sealing portion where each hole 110 remains in a void.

By assembling the plurality of such fine fibers 4 manufactured as described above, each of which is comprised of silica glass, a thermal insulator is manufactured. In the thermal insulator thus assembling the fine fibers 4, it is preferable that an average outer diameter thereof be 1 μm or more and 10 μm or less; in a cross section of each fine fiber 4, there exist a plurality of holes with an average outer diameter of 500 nm or less; and the internal pressure of each hole 110 is below atmospheric pressure, for example, 10 kPa or less. The reason why the average outer diameter of the fine fibers 4 is 10 μm or less is that the range of the outer diameter of conventional glass wool having no holes inside is 10 μm or less, and therefore, even if the hole 110 should be crushed, thermal insulating properties at least equivalent to those of the conventional glass wool can be maintained. Setting the average outer diameter of the holes 110 to 500 nm or less enables convective heat conduction inside the hole 110 to be efficiently controlled. A value of 10 kPa or less for the internal pressure of each hole 110 is significantly lower than the pressure that can be realized only by cooling down elongating temperature to normal temperature. With those settings, it is possible to excellently control the convective heat conduction inside each hole 110.

It should be noted that the example of the embodiment above describes a case where the fine fiber 4 is manufactured from the preform 3 using a plurality of silica glass pipes 1. However, in another example, the preform is prepared, while at least one of pressure around the preform having a plurality of holes; and that of inside the plurality of holes, is being reduced below atmospheric pressure. Drawing (elongating) while heating the preform into thread also enables manufacturing of a fine fiber in which at least a part of the plurality of holes remains. It should be noted that manufacturing such a fine fiber (thermal insulator) can also be realized by using a device shown in FIG. 3, for example.

Specifically, the manufacturing method comprises a sealing step and a non-sealing step, and the sealing step is carried out before and after the non-sealing step. In the sealing step, a sealed end for sealing each hole (sealing portion) is formed in the fine fiber obtained by drawing the preform. In the non-sealing step, the preform is drawn under such conditions that the internal pressure of each hole is reduced below atmospheric pressure and each hole remains.

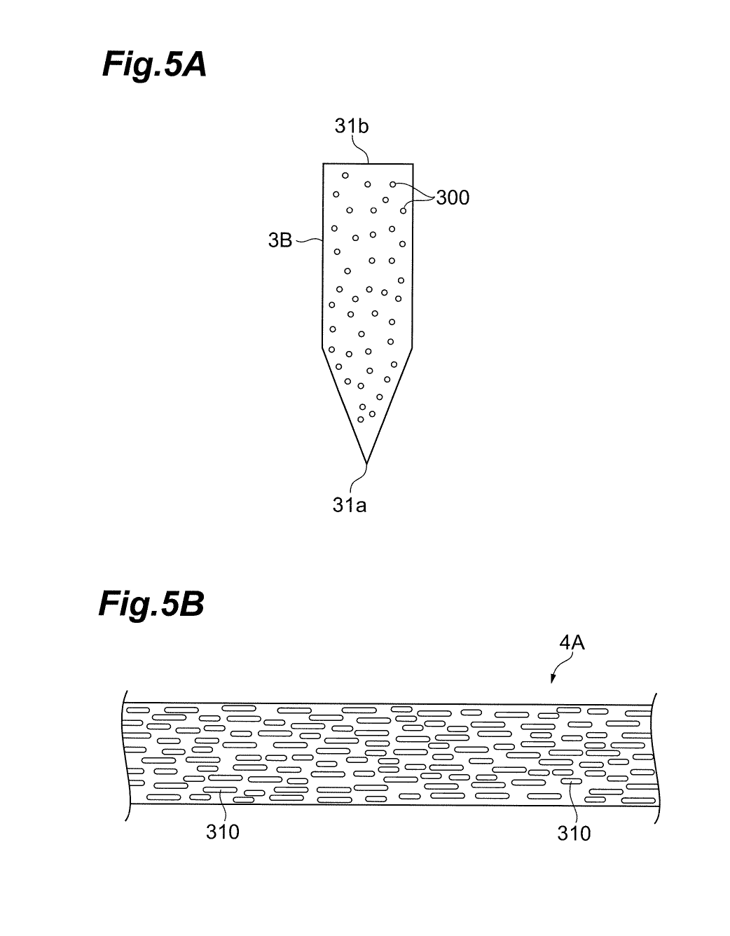

In further another example, the manufacturing method according to the present embodiment may use the preform including a foaming material that expands with heat (to be exact, that is a foaming region, which is hereinafter referred to). One example of the foaming region indicates each independent bubble especially generated inside silica glass constituting the preform. Additionally, as a method of forming the independent bubble in the preform, there is the method of forming, in which when a soot body is sintered to make a transparent silica glass preform, sintering conditions are adjusted so that a part remains unsintered (space remains between the soot). FIG. 5A shows a preform 3B including a foaming region 300, with a first end 31a and a second end 31b. The preform 3B is drawn by the manufacturing device of FIG. 3 and a fine fiber 4A with a cross-sectional structure shown in FIG. 5B, is obtained. In the fine fiber 4A, there exist a plurality of each independent hole 310 that has become evident with heat expansion of the preform, and the internal pressure of each hole 310 is controlled to be equivalent to or below atmospheric pressure.

It should be noted that setting conditions for the drawing using the device of FIG. 3 are, for example, that the first end 31a side of the preform 3B is placed in the reduced pressure environment below atmospheric pressure by the second pressure reducing section 13. While the heating section 12 is heating the first end 31a side of the preform 3B, the tension applying section 14 draws the preform 3B (corresponding to the silica glass foaming body disclosed in Document 1, for example) and the fine fiber 4A with the cross-sectional structure shown in FIG. 5B is produced. In the fine fiber 4A thus manufactured, the hole 310 that has become evident by expansion takes an extended shape along the longitudinal direction of the fine fiber 4A by the drawing, while the internal pressure is below atmospheric pressure. In the drawing, heating temperature and pressure of the preform 3B are controlled. Material of the preform 3B is not limited to silica glass, but may be any material, as long as a fine fiber having a hole can be produced therefrom by appropriate control of temperature, pressure and tension.

One example of the thermal insulating component according to the present embodiment, which is configured by assembling a plurality of silica glass fine fibers manufactured as described above, is directly installed to a portion necessary for thermal insulating treatment, or is packed into the portion, for example, when the portion necessary for thermal insulating treatment is closed space. Alternatively, another example of the thermal insulating component according to the present embodiment is manufactured so as to be an integrated one of the plurality of fine fibers 4 using an appropriate binder, and is installed to the part necessary for thermal insulating treatment. Alternatively, a further another example of the thermal insulating component according to the present embodiment is manufactured so as to be the one with the plurality of fine fibers 4 housed and sealed inside an appropriate jacketing material, and is installed to the portion necessary for thermal insulating treatment. In this way, the thermal insulating component (or thermal insulating member) of the present embodiment has a high degree of freedom in size, form and installation method.

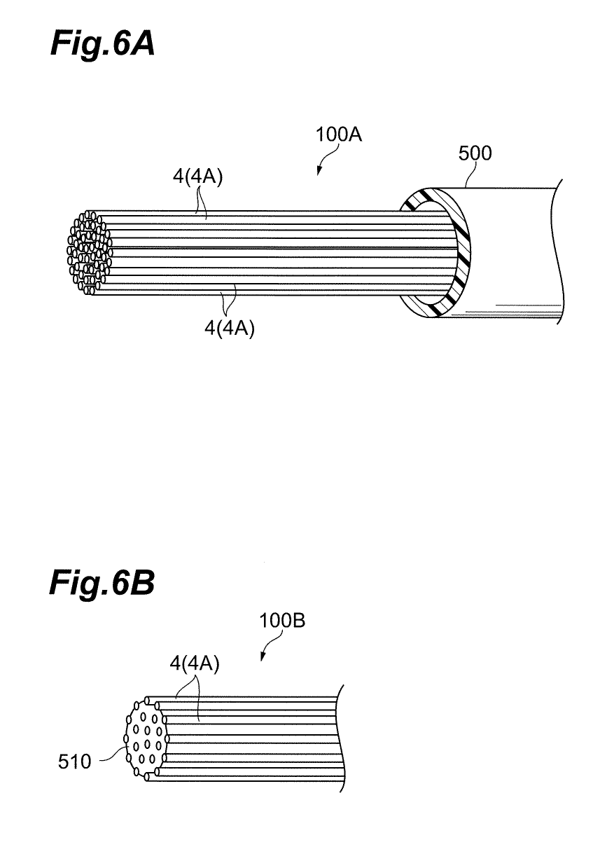

FIG. 6 shows various structural examples of the thermal insulating component according to the present embodiment. For example, in a structure of FIG. 6A, a thermal insulating component 100A includes the plurality of fine fibers 4 (4A) and an assembly of the fine fibers 4 (4A) has a structure bundled and covered with a jacketing material 500. On the other hand, in a structure of FIG. 6B, a thermal insulating component 100B includes the plurality of fine fibers 4 (4A) manufactured as described above, and space between those fine fibers 4 (4A) are filled with a binder 510.

It should be noted that, when the assembly of the fine fibers 4 is housed in the jacketing material 500 and sealed (FIG. 6A), reducing pressure inside the jacketing material 500 leads to that not only a hole inside each fine fiber 4, but also space between the fine fibers 4 are reduced in pressure. Such structure enables thermal insulating properties to further improve. Even if the jacketing material should be broken and the pressure inside the jacketing material 500 increases, the holes of each fine fiber 4 remain reduced in pressure and, therefore, a certain level of thermal insulating properties is maintained. Furthermore, when a part of a hole wall inside each fine fiber 4 is broken by shock or the like and the pressure inside the hole increases, the increased pressure of one hole causes very limited deterioration of the thermal insulating properties, because the hole inside each fine fiber 4 is intermittently sealed in the longitudinal direction of each fine fiber 4.

As described above, in accordance with to the present invention, it is possible to easily manufacture a thermal insulating fine fiber and a thermal insulator having a high degree of freedom in size and shape, and excellent thermal insulating properties.

What is claimed is:

1. A thermal insulator of an assembly of fine fibers, wherein an average outer diameter of the fine fibers is 1 μm or more and 10 μm or less,
a plurality of holes exist in each of the fine fibers, the holes having an average outer diameter of 500 nm or less in a cross section of each of the fine fibers, and
internal pressure of each of the holes is below atmospheric pressure.

2. The thermal insulator according to claim 1, wherein the internal pressure of each of the holes is 10 kPa or less.

3. The thermal insulator according to claim 1, wherein the fine fibers are comprised of glass.

4. A thermal insulating component including an assembly of a plurality of members each having the same structure as the thermal insulator according to claim 1, the thermal insulating component comprising:
at least one of a structure in which outside of the assembly is covered with a jacketing material, and a structure in which space between the members constituting the assembly is filled with a binder.

5. A thermal insulator including a fine fiber having a plurality of holes inside and an average outer diameter of 10 μm or less, wherein
each of the holes is sealed at both ends or at a plurality of places in an intermediate zone between both ends, and internal pressure of each of the sealed holes is reduced below atmospheric pressure.

6. The thermal insulator according to claim 5, wherein the internal pressure of each of the holes is 10 kPa or less.

7. The thermal insulator according to claim 5, wherein the fine fiber is comprised of glass.

8. A thermal insulating component including an assembly of a plurality of members each having the same structure as the thermal insulator according to claim 5, wherein
the thermal insulating component has at least one of a structure in which outside of the assembly is covered with a jacketing material, and a structure in which space between the members constituting the assembly is filled with a binder.

9. A method of manufacturing a thermal insulating fine fiber, comprising the steps of:
preparing a preform constituted by bundling a plurality of pipes, the perform having a first end and a second end opposing the first end;
sealing the first end side of the preform;
setting internal pressure of each of the pipes to be reduced below atmospheric pressure through suction of inner gas of each of the pipes carried out from the second end side of the preform;
making a fine fiber in which the plurality of pipes are integrated from the preform by starting softening from the first end side of the preform with the internal pressure of each of the pipes being reduced, and drawing the preform while shifting a softened portion toward the second end side;
forming a plurality of sealing portions in the fine fiber intermittently inside each of the pipes by intermittently changing, at a softened portion of the fine fiber obtained by drawing, at least one of temperature, number of twists, tension, internal pressure of each of the pipes, and external pressure; and
hardening the fine fiber, in a downstream side of where the sealing portions are formed,
whereby a thermal insulating fine fiber, in which a plurality of holes fixed and reduced in pressure by the sealing portions are intermittently provided inside each of the pipes, is manufactured.

10. The method of manufacturing a thermal insulating fine fiber according to claim 9, wherein the preform is comprised of glass.

11. A method of manufacturing a thermal insulator, wherein the thermal insulating fine fiber according to claim 9 constitutes a part or whole of the thermal insulator.

12. A method of manufacturing a thermal insulating fine fiber by preparing a preform having a plurality of holes extending in a longitudinal direction thereof, and drawing the preform in the longitudinal direction while softening the preform, the method comprising:
a sealing step of forming, while drawing the preform, a sealing portion for sealing each of the holes into the fine fiber obtained by drawing; and
a non-sealing step of drawing the preform under such conditions that internal pressure of each of the holes is reduced below atmospheric pressure and each of the holes still remains,
wherein the sealing step is carried out before and after the non-sealing step.

13. The method of manufacturing a thermal insulating fine fiber according to claim 12, wherein, in the sealing step, a plurality of such sealing portions are intermittently formed inside each of the holes by intermittently changing, at a softened portion of the fine fiber obtained by drawing, at least one of temperature, number of twists, tension, internal pressure of each of the holes, and external pressure, and
wherein the fine fiber is hardened, in a downstream side of where the sealing portions are formed,
whereby a plurality of sealed regions, fixed and reduced in pressure by the sealing portions, are intermittently provided inside each of the holes.

14. The method of manufacturing a thermal insulating fine fiber according to claim 12, wherein the perform is comprised of glass.

15. A method of manufacturing a thermal insulator, wherein the thermal insulating fine fiber according to claim 12 constitutes a part or whole of the thermal insulator.

16. A method of manufacturing a thermal insulating fine fiber, comprising the steps of:
preparing a preform including a large number of fine foaming regions that are expanded with heat;
expanding the foaming regions by heating the preform, and producing a large number of holes corresponding to the fine foaming regions;
producing a fine fiber by drawing the preform softened with the heat under pressure below atmospheric pressure into thread while the foaming regions are expanded;
cooling down and hardening the fine fiber, in a downstream side of where the preform is drawn; and
producing a fine fiber in which internal pressure of each of the holes generated due to expansion is controlled to be below atmospheric pressure in a state of the hardened fine fiber by adjusting temperature of the heat and the pressure applied to the preform in an expanded condition when drawing the preform.

17. The method of manufacturing a thermal insulating fine fiber according to claim 16, wherein the preform is comprised of glass.

18. A method of manufacturing a thermal insulator, wherein the thermal insulating fine fiber according to claim 16 constitutes a part or whole of the thermal insulator.
